(19) United States
(12) Patent Application Publication
(10) Pub. No.: US 2010/0134408 A1
(43) Pub. Date: Jun. 3, 2010

(54) Fine-motor execution using repetitive force-feedback

(76) Inventors: Susan E. Palsbo, Eugene, OR (US); Arthur R. Palsbo, Eugene, OR (US); Sidney Johnson, Reston, VA (US); Naomi Lynn Gerber, Bethesda, MD (US); Younhee Kim, Centreville, VA (US); Zoran Duric, Fairfax, CA (US); Walter Norblad, Eugene, OR (US); Matthew Hopkins, Scio, OR (US)

Correspondence Address: GEORGE MASON UNIVERSITY;OFFICE OF TECHNOLOGY TRANSFER, MSN 5G5, 4400 UNIVERSITY DRIVE, FAIRFAX, VA, 22030, US

(21) Appl. No.: 12/153,903

(22) Filed: May 27, 2008

Related U.S. Application Data
(60) Provisional application No. 60/940,168, filed on May 25, 2007.

(51) Int. Cl. G09G 5/00

(52) U.S. Cl. 345/156

(57) ABSTRACT

An individual's fine-motor skills can be assessed using a force-feedback haptic unit that includes an end-effecter and programmable settings. To assess these skills, a tangible computer readable medium initializes the programmable settings with a set of initial settings. It then presents a 3-D representation of a character or characters to a user. The user in turn is prompted to mimic the character(s) on a work space. While the user is attempting to mimic the character(s) using the end-effecter on the work space, timed stroke data are collected from the force-feedback haptic unit. Using the timed stroke data, an analysis is then generated to determine the user's precision and accuracy of mimicking the character.

### CROSS REFERENCE TO RELATED APPLICATIONS

The present application claims the benefit of provisional patent application Ser. No. 60/940,168 to Palsbo et al., filed on May 25, 2007, entitled “Fine-Motor Execution Using Repetitive Force-Feedback,” which is hereby incorporated by reference.

### REFERENCE TO COMPUTER PROGRAM LISTING APPENDIX ON A COMPUTER DISC

Two copies of a single compact disc (Compact Disc), labeled Copy 1 and Copy 2, are hereby incorporated by reference in their entirety. Each Compact Disc contains a Computer Program Listing Appendix as an ASCII text file. Entitled “GMU-07-037U_{—}2008-05-27_Computer_Program_Listing_Appendix_txt”, the ASCII text file was created on Compact Disc on May 27, 2008 and has a size of approximately 1,131,200 bytes. This file contains codes and algorithms concerning the present invention.

### BRIEF DESCRIPTION OF THE DRAWING

FIG. 1 shows an example of a flow diagram of assessing an individual's fine-motor skills using a force-feedback haptic unit.

FIG. 2 shows another example of a flow diagram of assessing an individual's fine-motor skills using a force-feedback haptic unit.

FIG. 3 shows another example of a flow diagram of assessing an individual's fine-motor skills using a force-feedback haptic unit.

FIG. 4 shows an example of a block diagram of force-feedback haptic unit.

FIG. 5 shows an example of a block diagram of force-feedback haptic unit system.

FIG. 6 shows another example of a flow diagram of a force-feedback haptic unit program.

FIG. 7 shows an example of generating haptic trajectories of a letter.

FIG. 8 shows an example of a bird's eye view of a virtual carriage.

### DETAILED DESCRIPTION OF THE INVENTION

The present invention embodies a technique for teaching individuals to learn how to write characters with the aid of a haptic device. In particular, these individuals are likely to be deficient with fine-motor skills and/or poor handwriting skills. Characters can be in the form of any language (e.g., English, Spanish, French, Greek, Chinese, Japanese, etc.) and can include alphanumeric characters, symbols, words and sentences, geometric shapes, markings, and punctuation. It should be noted that this listing of various types of characters is endless and that those that are mentioned merely serve as representative examples.

Overall, the present invention uses a force-feedback peripheral haptic unit, which may be connected to a computer. The computer may enable “sense of touch” instructions in drawing, printing or cursively writing characters via repetitive-motions. Training individuals with this sense of touch and repetitive motion can help stimulate the growth of their neural connections. In one embodiment, it can help adults who suffered a stroke, spinal cord injury (SCI) or traumatic brain injury (TBI) improve and/or regain at least some functional use and/or manipulation of weaker upper limb extremity(ies) through repetitive motion in post-injury rehabilitation. For example, Butefish et al. [35] has shown that repetitive training of isolated hand movements helps improve functional manipulation after stroke.

Additionally, this kind of training can significantly improve proprioceptive awareness and writing, as measured by accuracy and speed for those with developmental coordination disorders. Examples of such disorders include, but are not limited to, attention deficits, autism, mild cerebral palsy, mental retardation, and unspecified learning disabilities. Furthermore, this training can also be provided over the internet (telerehabilitation).

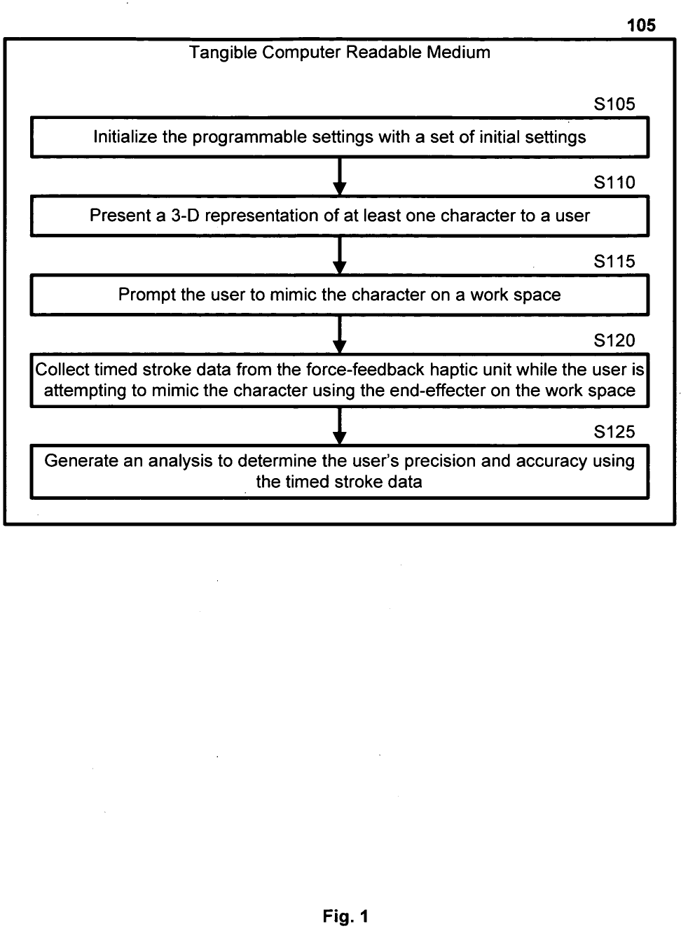

Referring to FIGS. 1-5, the present invention may be embodied in the form of a physical or tangible computer readable medium (e.g., computer program product, etc.), system, or device. In addition, methods of implementing the present invention are also embodied.

Examples of the tangible computer readable medium include, but are not limited to, a compact disc (cd), digital versatile disc (dvd), USB flash drive, floppy disk, random access memory (RAM), read-only memory (ROM), erasable programmable read-only memory (EPROM), optical fiber, electronic notepad or notebook, etc. It should be noted that the tangible computer readable medium may even be paper or other suitable medium in which the instructions can be electronically captured, such as optical scanning. Where optical scanning occurs, the instructions may be compiled, interpreted, or otherwise processed in a suitable manner, if necessary, and then stored in computer memory.

The instructions may be written using any computer language or format. Nonlimiting examples of computer languages include Ada, Ajax, Basic, C, C++, Cobol, Fortran, Java, Python, XML, etc. The instructions may also be written in MatLab Simulink, RealTime Workshop, and equivalent programs.

The instruction execution system may be any apparatus (such as computer or processor) or “other device” that is configured or configurable to execute embedded instructions. Examples of “other device” include, but are not limited to, PDA, cd player/drive, dvd player/drive, server(s)/client(s), computerized tablets, apparatuses receiving and analyzing input signals, etc.

The physical or tangible computer readable medium 105 may be encoded with instructions for assessing an individual's fine-motor skills using a force-feedback haptic unit having an end-effecter and programmable settings. As illustrated in FIG. 1, upon execution of the instructions, one or more processors may initialize the programmable settings with a set of initial settings S105; present a 3-D representation of a character to a user S110; prompt the user to mimic the character on a work space S115; collect timed stroke data from the force-feedback haptic unit while the user is attempting to mimic the character using the end-effecter on the work space S120; and generate an analysis to determine the user's precision and accuracy using the timed stroke data S125.

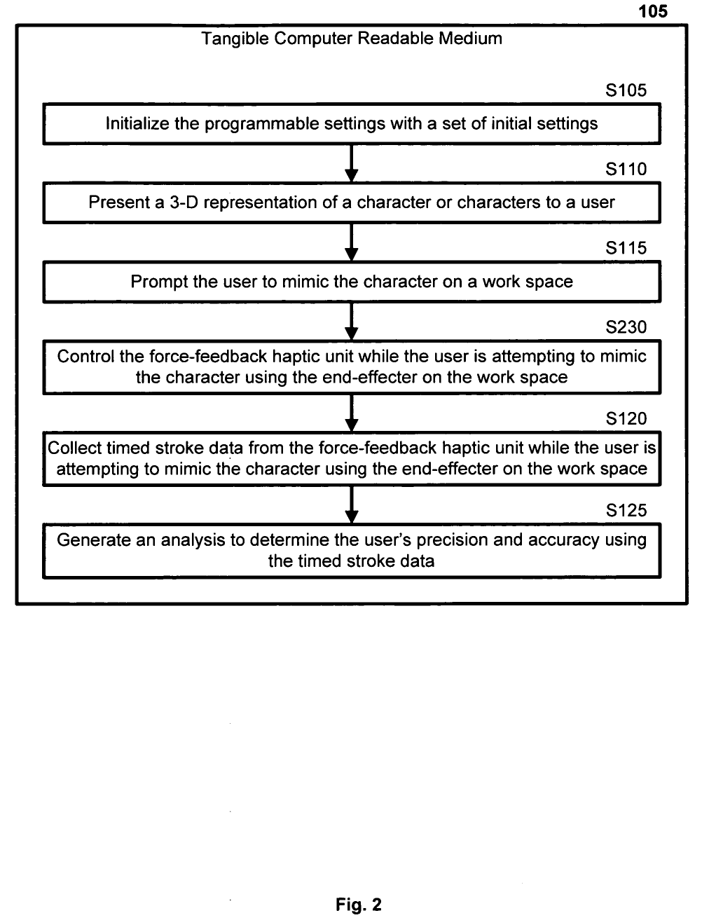

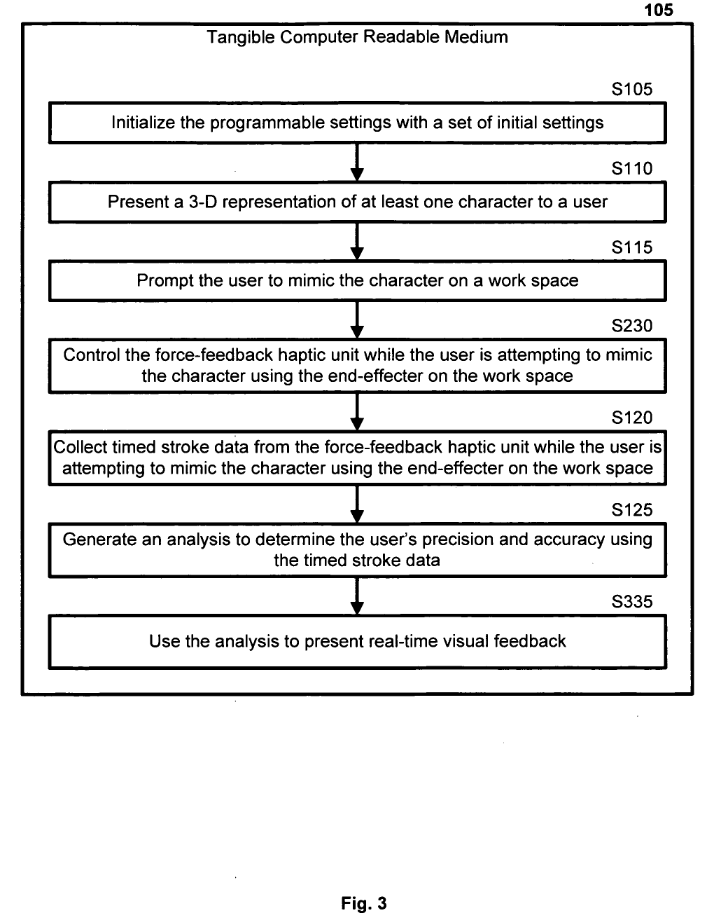

The medium 105 may also include controlling the force-feedback haptic unit while the user is attempting to mimic the character using the end-effecter on the work space S230, as shown in FIG. 2. Furthermore, the medium 105 may include using the analysis to present real-time visual feedback S335, as shown in FIG. 3. The real-time visual feedback may include an image of at least one stroke, which may be made by the user; an image of at least one stroke overlaid on an image of the character; or even statistical data. Examples of statistical data include, but are not limited to, hit rate data; error rate data; accuracy data; directional accuracy data; summary data; or two or more of these in combination. To calculate and analyze statistical data, a variety of statistical packages may be used. For instance, basic statistics packages may be R (by the GNU project), S (by Insightful Corp. of Seattle, Wash.) or SPSS (by SPSS of Chicago, Ill.). Advanced math and statistical packages may include Mathematica (by Wolfram Research, Inc. of Champaign, Ill.), Excel (by Microsoft of Redmond, Wash.), and OpenOffice Spreadsheet (by OpenOffice).

Collecting timed stroke data may be repeated multiple times, as determined by the user. Likewise, generating the analysis may also be repeated multiple times.

The analysis may include summary data for the timed stroke data that are collected through these repeated, multiple times. As for the summary data, it may include, but is not limited to, statistics (like the ones above); time-series analysis; and user-defined settings for the force-feedback haptic unit.

Each of the characters may be described in numerous ways. For example, it may be described as a quadratic curve, a cubic curve, a Bezier curve, a polynomial equation, or even a combination of the above.

Each of the time stroke data should include a timed sequence of x, y, and z coordinate data. Furthermore, the timed stroke data may also include lift data. Lift data may include a curve in a plane substantially perpendicular to the work space.

The programmable settings may be adjusted by using updated settings received from a trainer in response to the analysis. When setting the updating settings, a plan may be considered. Nonlimiting examples of the plan include a therapeutic intervention plan (such as moving the hand on and off a table top to a predetermined height with decreasing assistance over time (during a session or over repeated sessions) by the device); a treatment plan (such as guiding the hand to move directly away and then back to the trunk with an increasing number of repetitions per session, in order to build muscle strength); a guided plan (such as guiding the hand through the motions of writing a word or a name); and any combination thereof.

Among the features the present invention highlights, one involves remote sensing and function. In an embodiment, the force-feedback haptic unit may be configured to communicate with a remote force-feedback haptic unit. In such a case, a trainer may operate the force-feedback haptic unit, whereas the user may operate the remote force-feedback haptic unit, and vice versa. The trainer may accomplish such operation by using either an asynchronous “store and forward” operation or an interactive synchronous operation.

Both of these operations are well-known in the art. Asynchronous “store and forward” operation refers to the one-way, unacknowledged communication of messages between one computer (or system, network, Internet, etc.) to another. Interactive synchronous operation refers to a two-way communication of messages between one computer (or system, network, Internet, etc.) to another. In the latter operation, multiple parties may transmit data at the same time, in tandem, or randomly without having to wait until data being transmitted by the other parties is received.

Another feature of the present invention is that it may further include moving the end-effecter to a starting point.

In addition, the force-feedback haptic unit may be adjusted to accommodate different types of end-effecters. It may also accommodate deformities of a prehensile position and/or patterns. The end-effecter may include a force transducer. For instance, it may be placed at the tip of the end-effecter. Furthermore, force transducers may also be used in conjunction with the force-feedback haptic unit.

All of the embodied instructions for the tangible computer readable medium may be separately and independently embodied in the form of a device or a system for assessing an individual's fine-motor skills using a force-feedback haptic unit having an end-effecter and programmable settings.

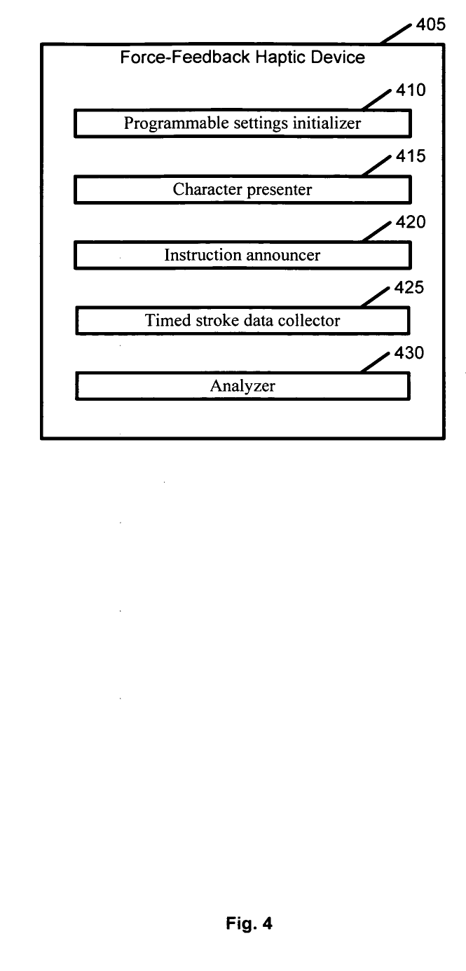

As shown in FIG. 4, these instructions may be incorporated into a force-feedback haptic unit (device) 405. Components include a programmable settings initializer 410, a character presenter 415, an instruction announcer 420, a timed stroke data collector 425, and an analyzer 430. The character presenter 415 may represent the character selected by the user in 3-D. In other words, in one exemplified form, the character may appear to be 3-D while being a 2D object. Each of these components may interact with one another.

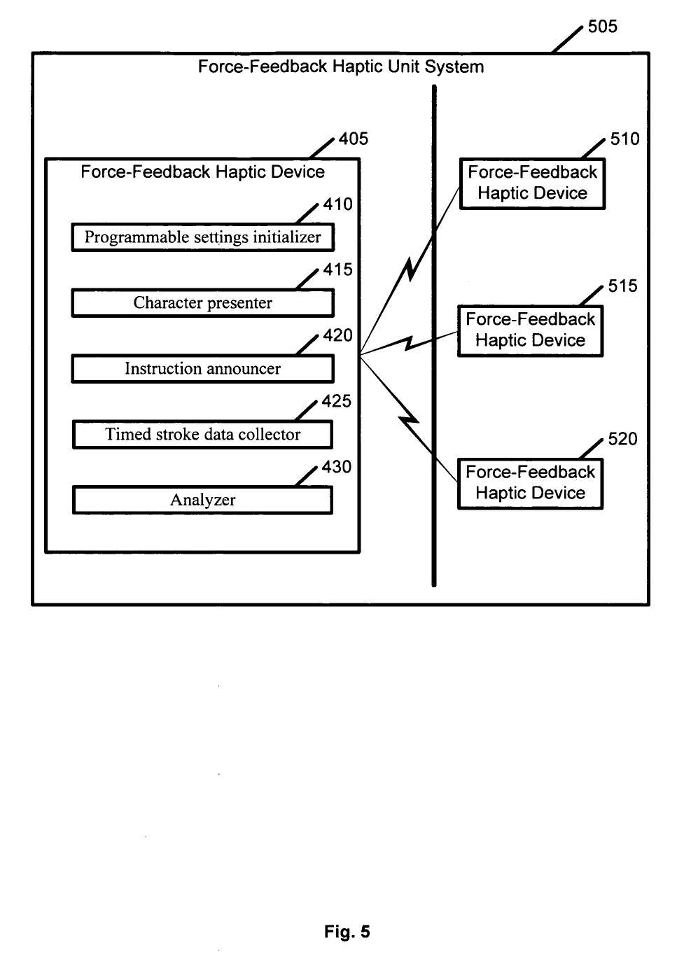

As illustrated in FIG. 5, the force feedback haptic unit may be implemented as a system 505. In this example, the system 505 allows for remote operation, one or more other force-feedback haptic units 510, 515, 520 may be used. Here, a trainer can use one or more remote force-feedback haptic units 510, 515, 520 to guide the user on the force-feedback haptic unit 405. Remote operations may be achieved either by using an asynchronous “store and forward” operation or an interactive synchronous operation. Like above, each of the components from each force feedback haptic device may interact with components from other force-feedback haptic units.

### I. INTRODUCTION

Handwriting is an integral part of every person's life. Taking a child as an example, handwriting serves as a major learning portion of the child's school experience. An estimated 30-60% of the elementary school child's class time is spent in fine motor and writing activities, including drawing within lines, connecting dots, printing, cursive script, and drawing numerals and geometric shapes [2].

As another example, handwriting serves as a major communication tool in the workforce. For instance, doctors often write prescriptions onto leaflets for patients to deliver to pharmacists. Secretaries may write notes on post-it pads to inform others of various messages. Even experts may examiner and decipher handwritten materials to aid the identification of a witness or a person on trial.

In general, handwriting is a very complex process that involves much more than being able to recognize a letter, number, or shape. Research has shown that neuromuscular ability [3] appears to be as important as visual-motor integration and visual cues [4]. Lamme [5] outlined six neuromuscular prerequisites for handwriting readiness. These include small muscle development, eye-hand coordination, utensil or tool manipulation, basic stroke formation, alphabet letter recognition, and orientation to written language. In addition, Benbow [6] listed four more muscular prerequisites: dominant hand use, midline crossing with the dominant hand, proper posture and pencil grip (the “tri-pod” grip), and the ability to copy the first nine shapes of the Developmental Test of Visual-Motor Integration [7]. Besides Lamme and Benbow, Denton et al. [8] summarized a relatively large body of research showing a strong correlation between handwriting and visual-motor integration (e.g., the ability to look at a figure and copy it accurately). Meanwhile, Volman et al. developed a regression model that suggests poor handwriting seems particularly related to a deficiency in visual-motor integration [4].

Several researchers [9, 10] hypothesize that proprioception (defined as understanding where parts of your body are in space or on a writing surface) is important. But, this connection has not been established definitively [8]. The theory is that a foundation in proprioception allows the brain to recognize errors. When first learning to write, younger children use visual cues (e.g., lines on a worksheet) to identify where to start and stop the letter shapes. As they grow, they switch to proprioceptive feedback, which allows them to write faster.

Children who cannot make this switch have several options in the classroom. For instance, they can obtain a copy of the instructor's notes. They can audiotape lectures. They can also learn to type (or use a keyboard), which appears to entail the use of different neuroprocessing skills. They may even choose to just write less.

However, society places a premium on handwriting and considers handwriting a key component of literacy. Society also considers handwriting as a key personal identifier on legal documents (e.g., your signature) and an important social skill (e.g., a handwritten thank you note). Even the recent decision by the College Educational Testing Board to include a handwritten essay in the verbal SAT has made legible handwriting into a high-stakes examination. Thus, parents and educators continue to place proficient handwriting as a goal on their children's individual education plans (IEPs).

Given the emphasis on handwriting, it is not surprising that several specialized programs have been developed to teach it. Studies show that school-based occupational therapy programs can significantly improve handwriting legibility [11]. Most programs include a combination of visual perception and letter formation training [12, 13].

However, most programs omit the proprioceptive feedback. An exception is “Handwriting Without Tears” (HWT). HWT is a comprehensive printing and cursive writing program developed by an occupational therapist [14]. This program engages the child's entire body in letter formation and uses many different tactile cues. A recent pre-test/post-test trial of HWT showed statistically significant improvement for children with illegible handwriting, with greater improvement seen in children who qualified for special education [15].

Even then, HWT has some mechanical limitations deriving from its reliance on traditional media. First, HWT is a very labor-intensive program that requires an instructor or parent to lay his/her hand on top of the child's hand to guide the child through letter formation. Second, when the child uses a slate, force-feedback exists only at the slate boundaries and only in the horizontal plane. Third, there is no process to collect objective data on the child's performance.

Consequently, what is needed is a much simpler program that allows one to remotely teach others handwriting techniques. The program should enable force-feedback at all stages and in all areas of the writing surface. Furthermore, the program should freely enable spatial and three-dimensional (3-D) force-feedback (e.g., vertical, horizontal, diagonal, elevation, curvature, etc.). Moreover, the user's performance should be recorded for objective analysis.

### II. MOTOR LEARNING THROUGH REPETITION

The normal brain and central nervous system develop as children learn how to communicate and use complex tools. Unfortunately, a large percentage of children have difficulties with auditory and visual processing, complex motor movement, below average fine-motor ability, problems in the motor components of handwriting and spatial problem solving, low coordination, and poor balance [23]. This profile is commonly termed as “developmental coordination disorder” (DCD).

DCD has multiple origins. These include, but are not limited to, cerebral palsy, perinatal or neonatal stroke, autism, and attention deficit disorders/attention deficit hyperactivity disorders (ADD/ADHD), etc. A meta-analysis of 50 studies of children with DCD found pronounced deficits in proprioceptive information processing, especially in visual-spatial integration [24].

Similar neurological deficits in proprioceptive information processing can be acquired after birth through injury (e.g., a stroke, spinal cord injury (SCI), traumatic brain injury (TBI), etc.) or through disease (e.g., Parkinson's disease, multiple sclerosis, etc.).

However, being born with a neurological impairment causing DCD or being a person (adult or child) having sustain neurological injury does not necessarily mean functional ability is permanently lost. Neuroimanging studies in adult monkeys show that some neurons are bimodal, responding to both touch and visual information [27, 28]. These studies provide clues about how the brain encodes proprioception.

It is believed that the sense of proprioception is a function of tactile feedback, visual feedback, and duration. Generally, as tactile feedback increases and duration increases, so does proprioception. Tactile feedback and duration are deemed as independent variables, whereas proprioception is a dependent variable. Tactile feedback is a continuous variable of force-feedback measured in pounds of force. Duration is a continuous variable measured in seconds and number of repetitions. Proprioception can be measured indirectly by scoring on the Evaluation Tool of Children's Handwriting (ETCH) test. Alternatively, proprioception can be measured directly and objectively by quantifying the error between the desired scribing tasks and the actual scribing task.

Learning is the chief occupation of childhood. Brain scans of adult monkeys learning to use tools show that neural circuits are reorganized [29], and Maravita and Iriki [30] suggest that new bimodal neurons are developed during the learning process. Using functional magnetic resonance imaging, Karni et al. [31] showed that training in complex motor tasks activates a larger portion of the primary motor cortex as more time is spent practicing, suggesting experience-dependent reorganization. Similarly, a study on unimpaired humans of a simple thumb movement repeated over 30 minutes was effective in inducing cortical representational changes [32]. German neuroscientists have demonstrated that cortical mapping is modulated by handwriting tasks with somatosensory feedback [33, 34]. Thus, it is expected that children with DCD or people with neurological injury can overcome proprioceptive deficits if their brains are stimulated to induce cortical representational change.

Similarly, many adults with stroke, SCI, or TBI acquire the same functional proprioception deficits shown by children with DCD. One therapeutic approach is “constraint-induced therapy” (CIT) [36, 37]. Under this approach, particularly post-stroke CIT, the more functional limb is constrained so the patient is forced to use the weaker limb. The patient may repeat exercises in a clinic under the direction of a physical therapist, or in unstructured activities throughout the day at home or work. Two recent meta-analyses concluded that most human clinical trials have been under-powered, but that CIT may help some people with stroke regain some functional use of the upper limb [38, 39]. Liepert and coworkers were the first to show that constraint-induced repetitive motions of the upper extremities produce a large cortical reorganization in persons with stroke(s) [40, 41]. To further test these findings, a well-designed placebo-controlled trial using CIT for 6 hours a day for 2 weeks showed functional gains sustained over at least two years [42]. A much earlier study in 1977 on monkeys showed sustained use for the duration of the monkey's life [43]. Thus, these findings indicate that once neural pathways are established in children with DCD, gains in proprioception are expected to be sustained indefinitely.

Another therapeutic approach to rehabilitation through repetition is to use therapists to manually guide the affected limb through the motions. However, this approach is labor intensive and tends to be inconsistent as the therapist becomes physically or mentally tired. These shortcomings engendered interest by bioengineers in creating robotic devices to take the place of the therapists in repetition motion stroke rehabilitation [44, 45].

While numerous bioengineering proof-of-concept studies for using robots in assisted walking for patients with SCI [46], randomized trials have yet to be publicized. The limited published bioengineering studies suggest that robotic-assisted repetitive motion has functional outcomes equivalent to therapist-assistive repetitive motion for the upper arm [47], with statistically significant and sustained improvements in isolated movement control and improved wrist/finger and shoulder/elbow performance. Likewise, in a matched study design, functional gains were comparable for stroke patients receiving CIT from therapists or delivered by a computer work station and task device [48]. A small randomized controlled trial between therapist-assisted and robot-assisted repetitive movements showed equivalent gains in arm function for adults with chronic stroke [49]. Thus, repetitive motion therapy for children with DCD can be provided through peripheral haptic units.

Haptics refer to the sense of touch. The feasibility of haptics for limb rehabilitation has been demonstrated in specific case studies. For instance, bioengineers in Italy [50] and Sweden [51] have shown that haptics can be used in upper limb rehabilitation after a stroke.

Force-feedback haptics refer to the use of tactile boundaries for testing the sense of touch. Based on recent studies, force-feedback haptics is expected to be an efficient and effective method to provide repetitive motion therapy to children with DCD. For instance, one study has shown that two chronic post-stroke patients demonstrated increased strength and improved function [52]. In another study, Italian researchers applied the Rutgers force-feedback haptic glove and software to evaluate manipulative abilities under a tele-assessment scenario [53], as well as to provide physical therapy and rehabilitation exercises (e.g., DigiKey, ball, power putty, peg board and ball game) [54]. Two engineering teams reported proof-of-concept studies in 2005 for force-feedback training lettering, using the Phantom Omni by SensAble of Woburn, Mass.

However, using force-feedback haptics alone may not be sufficient. To enhance fine-motor skills, the training exercises must be goal-oriented. In general, people without disabilities seem to acquire complex fine-motor skills more easily when they understand the context of using the skill. Nonlimiting examples include preparing a meal rather than assembling a puzzle [57], learning to use chop sticks [58], and throwing dice rather than a rote wrist rotation exercise [59]. Research on children with DCD, such as those with cerebral palsy [60], show that goal directed therapy show better outcomes than intensive rote exercises. Since most children with disabilities receive school-based rehabilitation therapy, it is not surprising that rehabilitation scientists are developing outcome measures using school-related goals [61]. These include the Cognitive Orientation to Occupational Performance (CO-OP) that has been tested on children with DCD, activity focused motor interventions for children with neurological conditions [62], goal-attainment scaling (GAS) [63, 64], and the Perceived Efficacy and Goal Setting System (PEGS) [65]. Therefore, to stimulate new neural pathways, force-feedback haptics need to be attached with some goals, such as classroom or daily-life goals.

Where a classroom goal is selected, one exemplified embodiment may include handwriting. While acknowledging that “legible handwriting” is a subjective measure, a considerable amount of research has tried to determine why 10-20% of students cannot write legibly. The construct of illegible handwriting includes incorrect letter formation or reversal, inconsistent size and height of letters, variable slant and poor alignment, and irregular spacing between words and letters [66, 67, 68]. Currently, the “only test of manuscript writing that rates global legibility” is ETCH, which is nonetheless a subjective measure [69, 70]. Hence, to avoid subjectiveness, data collected by a haptic unit can be used to place quantitative boundaries around subjective rehabilitation outcome measures and handwriting legibility.

### III. 3-D FORCE-FEEDBACK HAPTIC PROGRAM

Using as a platform, a graphic user interface (GUI) for programming complex haptic functions, the computer-readable program may be designed to help people learn writing and/or drawing characters using a haptic device (such as the Phantom Omni or Phantom Premium 3.0/6DOF by SensAble of Woburn, Mass., Novint Falcon by Novint of Albuquerque, N.Mex., etc.). It may be ideal for the GUI to have a tool box that can be integrated with models that generate hardware description language (HDL) code, such as Simulink by The Mathworks of Natick, Mass. The GUI should also be integratable with a haptic device interface.

The GUI may comprise a multitude of control buttons. Nonlimiting examples include mode, character, handedness, size, speed, repetition, audio, and force. Each of these control buttons may be selected and adjusted by the user.

“Mode” may encompass three types of mode: trace mode, assessment mode, and guess mode. The program may be driven differently depending on the mode.

“Character” refers to the character that the user selects to learn. Characters can be in the form of any language (e.g., English, Spanish, French, Greek, Chinese, Japanese, etc.) and can include any letter, number, symbol, word, sentence, mathematical equation and/or operation, shape, marking (such as a line, scribble, etc.), etch, pattern, and punctuation.

“Handedness” refers to right-handed or left-handed mode. Depending on which handedness is chosen, the specific character trajectory is loaded for character model points.

“Size” refers to the size of the character. Depending on the size, the character model trajectories may be scaled using the exemplified scaling function described above.

“Speed” refers to the speed of the haptic device's movement. Points along the trajectory may be sampled according to time. At each time step, the end-effecter moves a unit distance until it reaches the end point of the trajectory. The unit distance may be determined by the selected speed. The higher the speed, the fewer the points are sampled. Thus, higher speeds equate to an increased speed of the haptic device's movement.

“Repetition” refers to the selected number of times a user wants to repeat the tracing of the characters.

“Audio” refers to sound prompts. Examples include “Get Ready” and “Go.” These prompts inform the user to wait, move, act, stop, etc. The sound may be adjusted with on or off buttons. Moreover, the loudness of the sounds may also be adjustable by increasing or decreasing the volume bar.

“Force” refers to the amount of force exhibited by the force slider in the trace mode. A higher selected force causes the haptic device to provide the user's hand with more strength in guidance. In the assessment mode, the force is expected to be set to the minimum so that the device doesn't move unless the user makes a move.

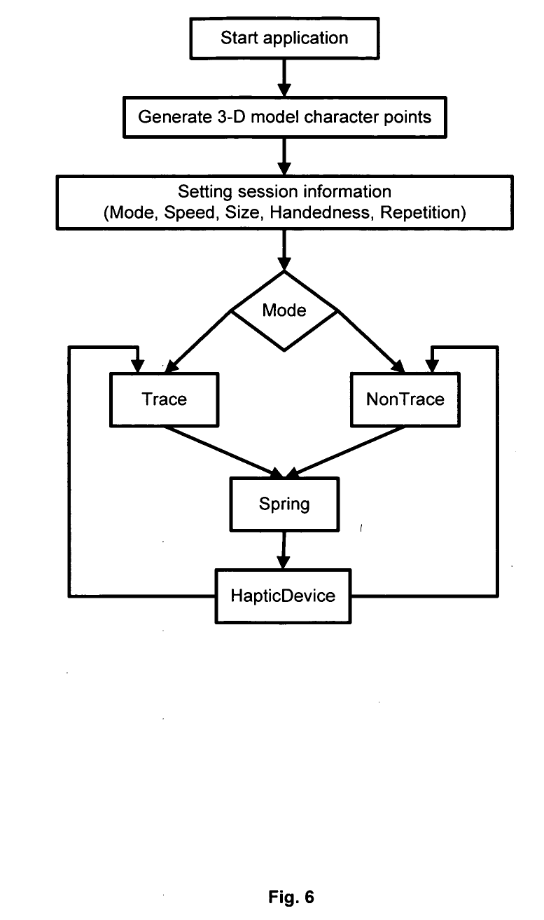

Referring to FIG. 6, when the application is started, the user may be brought to a character selection screen, whereupon the user selects a character (such as “A” or “cat”) or a sequence of characters (such as “A is for Apple” or “4+5=9”) for tracing model character trajectories. After the selection, the program may ask the user to select a mode and/or establish some tracing parameters. For example, tracing parameters may allow the user to control and adjust the character size, handedness, speed, repetition, force of the end-effecter, audio prompts, etc.

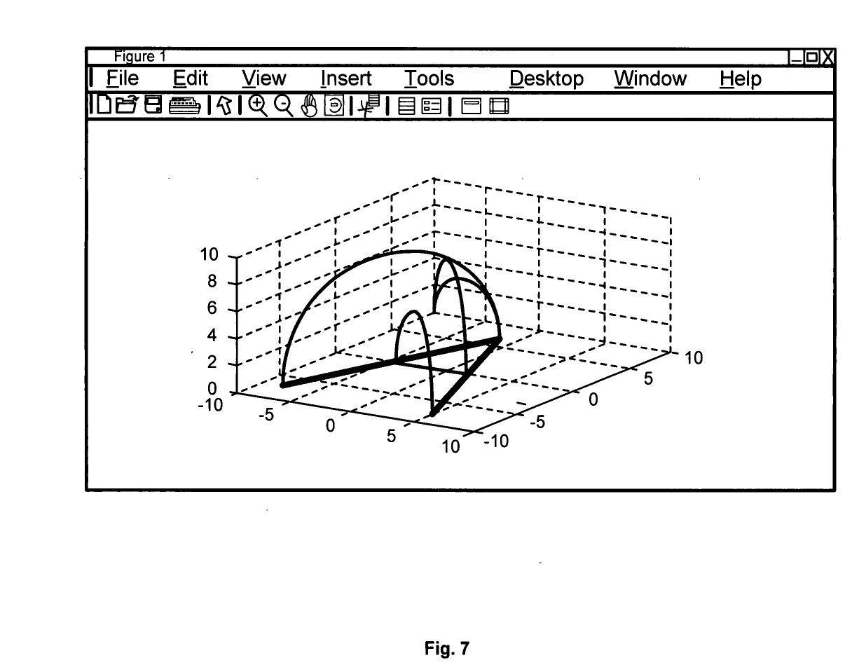

Model character trajectories are sequences of points representing strokes, in which the end-effecter is in contact with the surface or is lifted off. Force-feedback may be provided on each stroke or lift made by the user. FIG. 7 illustrates an example of how haptic trajectories of a letter can be generated. Here, the trajectories are also shown being adjusted in 3-D by scale, rotation, and transfer matrix.

Scale refers to the changing of the size of the characters. Rotation refers to rotating the work space. Work space refers to the area or surface where the user traces or recreates the character. The present invention allows for the work space to be tilted an angle (e.g., tilting the work space 5, 10 or 15 degrees with respect to a zero degree plane) to make it easier for the user to generate the characters. Hence, when the user feels more comfortable with writing on the slanted surface instead of the horizontal one, the work space can be rotated.

As an example, the rotation matrix may be given as follows:

$$RM = [ \begin{matrix}1 & 0 & & 0 & & 0 ; \\ 0 & cos ( theta ) & & - sin ( theta ) & & 0 ; \\ 0 & sin ( theta ) & & cos ( theta ) & & 0 ; \\ 0 & 0 & & 0 & & 1\end{matrix} ] ;$$

The transfer matrix refers to translating the location of the model points in 3-D space. As an example, the transfer matrix may be given as follows:

[NX, NY, NZ]=Transfer_{—}3DM(X, Y, Z, tx, ty, tz)

NX=X+tx;

NY=Y+ty;

NZ=Z+tz;

For the program to work, the program may incorporate various object blocks. One of the object blocks necessary for the program is a block that collects input. This block may be called FindMode block. Input for the FindMode block includes (1) character input, (2) current end-effecter position, (3) start session input, and (4) mode input. Character input may include factors such as the character's index, size, handedness, speed, and rotation.

In one embodiment, the modes (the 4^{th} input above) of the computer-readable program include a trace mode, an assessment mode, and a guess mode. Depending on the selected mode, the program flows either to a Trace block or a NonTrace block. Whichever is selected, the other 3 inputs above (namely, (1) character input, (2) current end-effecter position, and (3) start session input) would flow to that mode.

If the user selects the “trace mode” on the GUI interface, the program flows to the Trace block. Here, the haptic device drives the end-effecter along the trajectory of the corresponding character. This movement is expected to have the same effect as when a teacher or rehabilitation therapist holds and guides a student's or user's hand. The availability of this mode allows haptic boundaries to be placed so that it can help the user to transition from visual to proprioceptive feedback.

The end-effecter is defined as any writing instrument or equivalent object that is used by the user to recreate the character. For example, the end-effecter can be a stylus, pen, pencil, compass, brush, glove, fingertip, etc. To make the end-effecter move, the program includes a programming object block called HapticDevice. This block helps enable the end-effecter move to a specific location with a specific force by taking the inputs of a force and a desired location into consideration.

Inputs for the Trace block include, but are not limited to the ones listed above, namely (1) character input, (2) current end-effecter position, and (3) start session input. When the application starts, the Trace block may load the 3-D model points for each of the characters generated. At each time slot, this block may return a position in 3-D that the end-effecter is expected to be located next. Such position in 3-D may be determined by the character, handedness, speed, and size. Each of the user's strokes from one point to the next is timed and analyzed for precision and accuracy. There may be multiple points along the tracing pattern to guide the user along the character's trajectory. For instance, if the character “X” is to be drawn, there may be as few as two points (from start to finish for each line of the “X”). Or, there can be, for example, many points (e.g., 5, 10, etc.) along each line of the “X” as programmed. As the character is being drawn, the results of the user's efforts may be seen on the work surface or GUI screen. These efforts are recorded, calculated, and analyzed by the 3-D force-feedback haptic program to determine how well the user is performing. Output generated is generally the next point where the end-effecter should be positioned for the correct tracing of the character.

If the user selects any other mode (i.e., assessment mode or guess mode) on the GUI interface, the program flows to the NonTrace block. Input to this block is the same as input to the Trace block. In essence, inputs include, but are not limited to, (1) character input, (2) current end-effecter position, and (3) start session input. However, generated output is somewhat different. Here, the output is usually the point among all the character model points that is closest to the current end-effecter position.

Where the assessment mode is selected, the haptic device does not drive any movement. Instead, the haptic device will depend on the user's movement or gestures. Here, the force of the haptic device is set to the minimum. Such setting allows the user to entirely take command of the end-effecter and trace a character on the work surface. As the tracing takes place, the program may record the points that the user has traced, including lifts. As the user finishes tracing the character, the program may evaluate the user's writing by comparing the recorded points to the model points of the character.

The “assessment mode” complements the use of haptics well because it does not “drive” the user's hands through the stroke. This mode may be used at the start and end of a training session or sequence of sessions to measure progress over time. It may also be used to modify the therapeutic or instructional interventions.

The guess mode may be characterized as a hybrid of the trace mode and the assessment mode. Where the guess mode is selected, the haptic device provides some force to aid the user with no visual representation, for instance, on the computer screen. The force may be set by default at the mean of the minimum and maximum setting. For example, if the minimum is 0 and the maximum is 100, then the mean would be 50. However, the force may be adjusted to the user's preferences. Whatever force is selected (unless it is “0”), the user may move the end-effecter until the sides of the shape provide force-feedback. The user may move the end-effecter in any direction and start at any point. Hence, this mode allows the user to attempt to guess the geometric shape, letter, or other character using only proprioceptive sense, and then to verify the shape visually by selecting a “reveal” button on the computer screen.

Whichever mode is selected, the user is directed to attempt to trace or recreate the character on the work space. As the user carries on the exercise, the user's movement is timed and analyzed by the 3-D force-feedback haptic program.

Moreover, at each timed tracing/recreation step of the model character trajectory, the user movement path and the current haptic device end-effecter location are updated. In one embodiment, they may be updated in the upper right panel of the GUI window. The current haptic device location may be marked (e.g., as a small red cross) and the user path may also be marked (e.g., as a white line) in the display panel. Updates may be achieved using a GUIUpdate block. This block may be implemented using an S-function, which is a user defined block. In the trace mode, when the user lifts the end-effecter from the work surface to move to the next stroke, the path the user already traversed has ended and a new path is started. To update the screen properly, the signal may be passed when each stroke starts the GUIUpdate function block. In assessment mode and guess mode, if the user takes the end-effecter off the surface, the program recognizes that the new stroke has started.

Outputs generated from either the Trace block or NonTrace block serve as input for the Spring block. Spring block inputs may include, but are not limited to, the current location of the end-effecter, the desired location of the end-effecter, and force coefficients. The Spring block may generate force commands that control the haptic device's position and the moving force.

These force commands may be used as input for the HapticDevice block. Using such input, the HapticDevice block may output the Cartesian position of the device. In essence, the HapticDevice block may drive the haptic device to a certain position based on the given force command. The output of this block may give rise to device position information, which may be used as input for the Trace block or NonTrace block. This latter input helps fuels the repetitive nature of the 3-D force-feedback haptic program to allow the user to repetitively trace or recreate the same/different character.

It should be noted that during each step, the GUI screen may be updated to show the user's progress when moving the haptic device. Such updates may help provide the user not only with motion feedback, but also visual feedback.

Each time the user finishes tracing a character, the program may prompt the user as to whether the user wishes to repeat the tracing of the same character(s). Alternatively, the program may ask whether the user would like to repeat the tracing motion with a different character. Whichever is selected, the program permits the user to repeat the tracing of the same or different character(s) in as many times the user wishes. In addition, the program may also prompt the user to select which mode the user desires to attempt. By having a repetitive mode selection capability users are granted the flexibility to alternative among the various modes.

One or more evaluation reports may be generated as well. In one embodiment, these reports are generated by MatLab. For instance, the user's trajectories may be recorded in the Matlab work space. Hit ratios may be calculated by comparing the user's trajectories to the letter model's trajectories. In such example, the evaluation may be displayed as a Matlab figure.

Furthermore, any of the user data can be saved. The program includes a name field (“Name” button) where a user name may be entered. When the “Save” button is selected, all of the points the user has visited in the session may be saved in a program's format (e.g., MatLab format, etc.) having the user's name. When the “Plot” button is selected next to the “Save” button, the evaluation figure may be displayed with the user's name.

Data that have been collected may be analyzed in different ways. The simplest way involves using linear mixed effects models. For example, the following linear mixed effects model may be used:

Yᵢ=Xᵢβ+Zᵢbᵢ+eᵢ (1)

Yᵢ represents the repeated measurements for the ith individual including haptic force, and duration. Xᵢ represents a design matrix that characterizes the systematic part of the response (e.g., depending on covariates and time). βᵢ represents a vector of fixed effects. Zᵢ represents a design matrix that characterizes random variation in the response attributable to among-unit sources. bᵢ represents a vector of random effects. eᵢ represents a vector of within-unit errors characterizing within-unit variations. Different covariance structures of eᵢ may be explored to model the correlations among different response variables, as well as the correlations among the repeated measurements for each response variable. The linear mixed effects model may allow the modeling and “estimation” of individual trajectories.

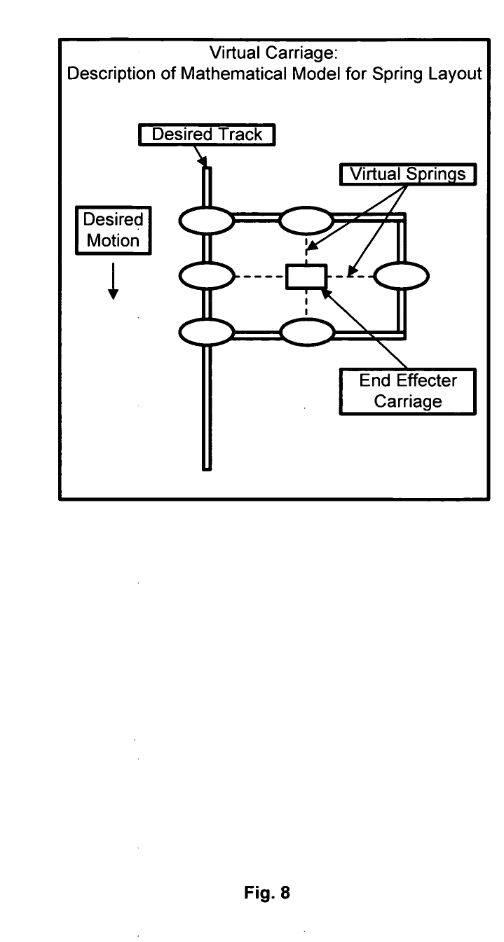

In a more complex example that provides better analysis, data may be analyzed using a multitude of force equations. To help visualize the way the forces work, the concept of a virtual carriage may be perceived, as illustrated in FIG. 8. The virtual carriage serves to provide adjustments in the spacing the characters and analyze how quickly the user can move from a point in a character to another point. The virtual carriage may function by picking up the ball of the haptic device and moving it from point to point. As the virtual carriage moves the ball, the ball moves the end effecter. Presented in a bird's eye view, the desired track represents the direction the end-effecter is supposed to move. The desired track may be a line, curve, S-shape, runs at an angle, etc. As the frame moves down the track within the virtual rigid frame, the forward spring may increase in force and the after spring is expected to decrease in force. The force equation for a spring may be given as:

F=−kd (2),

where k is a constant (that can change) and d is displacement (which may be used to determine stroke distance).

Over time, using this equation, the hand holding the end-effecter may be compelled to move with the frame as the forces grow. The springs to the left and right help keep the end-effecter on the track.

However, when the virtual carriage is displaced from the desired track, the virtual carriage tends to start to orbit the desired point as it moved. Without any damping forces, an orbital motion will result. In other words, the virtual end-effecter carriage (the end-effecter on the haptic device) will begin to orbit around its desired position with very little displacement. To resolve this orbit problem, a damping force is included into equation (2) to create the following equation:

F=−kd+cv (3),

where c is another constant (that can change) and v is velocity. The velocity, which includes a time element, helps retard the force from displacement (to keep the end-effecter from orbiting), and thus making it move slower). In addition, by adjusting the constants in Equation (3), the spring force and damping force may be tweaked.

The spring and damping forces may also be shaped to create a virtual straw where the user can move within. The virtual straw means that when the user is close to the desired track, the force should be small. However, as the user moved away from the desired track, the force would grow slowly at first. Then, the force of wall would be felt. To accomplish this force effect, the force equations were turned into quadratics:

Fₓ=k₁·dₓ²+k₂·dₓ−c₁vₓ²−c₂·vₓ

F_{y}=k₁·d_{y}²+k₂·d_{y}−c₁v_{y}²−c₂·v_{y}

F_{z}=k₁·d_{z}²+k₂·d_{z}−c₁v_{z}²−c₂·v_{z} (3)

The first and second orders in Equation (3) tend to provide a way to map the forces and shape the force curve. The constants for the first order may be greater than about 1. The constants for the second orders may be between about 0 and about 1. The net effect may resemble a trough or a shallow parabola, so that the second order can “catch up” with the first order. The purpose of such effect is to allow the user to have a free motion or a greater range of motion of the end-effecter.

Using the x, y, and z coordinate data from Equation (3), the timed stroke data (including timed sequence (or time-series) of x, y, and z coordinate data) and lift data can be calculated as each stroke is attempted by the user. To analyze the calculations, a statistical program (such as SPSS, R, S, Mathematica, Excel, OpenOffice, etc.) may be used. Results may indicate how precise and accurate the user was in mimicking the character.

### IV. EXAMPLES OF HAPTIC DEVICE INCORPORATING THE 3-D FORCE-FEEDBACK HAPTIC PROGRAM

Various kinds of haptic devices may be used to incorporate the 3-D force-feedback haptic program. Examples include, but are not limited to, the Phantom Omni, the Phantom Premium 6 DOF, and the Novint Falcon.

Where a haptic device by SensAble is used, haptic programming may be based on their OpenHaptics Toolkit. This toolkit may include the Haptic Device API (HDAPI) and the Haptic Library API (HLAPI). HDAPI generally provides low-level access to the haptic device. HLAPI is generally built on top of the HDAPI and provides high-level haptic rendering. While the present invention may use either HDAPI and/or HLAPI, the HDAPI is preferred because forces should be sent directly. However, HLAPI may be integrated to take advantage of its great design for high-level haptics scene rendering and its ease of synchronization between the haptics and graphic threads. Typical HDAPI uses may include initializing the drive, initializing the scheduler, starting the scheduler, performing some haptic commands using the scheduler, and exiting when done.

When combining haptics with 3-D graphics, one issue to consider is the refresh rate. Often, graphic applications refresh the display about 30 to about 60 times per second to provide a continuous motion for the human visual system. However, haptic applications may refresh the forces at 1000 times per second to provide the kinesthetic sense of stiff contact. Therefore, to avoid this problem in haptic programming, two separate threads need to be created to perform haptics and graphics concurrently. Furthermore, each rendering loop would need to be run at its respective refresh rate. Since their refreshing rates may be different, the loops may be generating frames for proper synchronization between the two threads. To ease the synchronization between the haptics and graphics threads, HLAPI may be used.

Another issue to be concerned is the work space. Haptic devices may have a coordinate system called Workspace System. HDAPI may provide a function to query the dimensions of the Workspace System. The following shows an example of such function:

HDdouble aUsableWorkspace[6];

HDdouble aMaxWorkspace [6];

hdGetDoublev (HD_MAX_WORKSPACE_DIMENSIONS, aMaxWorkspace);

hdGetDoublev (HD_USABLE_WORKSPACE_DIMENSIONS, aUsableWorkspace);

Where a parameter HD_MAX_WORKSPACE_DIMENSIONS is present, it refers the maximum extents of the haptic device work space as (minX, minY, minZ, maxX, maxY, maxZ). There is no guarantee that forces can be reliably rendered in all that space. However, the space returned with the HD_USABLE_WORKSPACE_DIMENSIONS parameter helps assure that forces are rendered reliably.

For example, if a PHANTOM Premium 6 DOF device were to be selected, the maximum work space may be set to [−450, 0, −150, 450, 900, 150] in millimeters. In such range, the usable work space may thus be [−450, 0, −150, 450, 900, 150], in millimeters. These work space parameters mean that x may range from about −450 to about 450 (90 cm), y may range from about 0 to about 900 (90 cm), and z may range from about −150 to about 150 (30 cm).

In another embodiment, the Limited Edition Novint Falcon may be selected. An example of the usable work space parameters for this model may be designated as follows: x plane: 4 inches; y plane: 3 inches; and z plane: 3 inches. It should be noted that these ranges may be increased or decreased.

To display objects in a desired GUI on computer screens, a series of transformations may be performed: viewing, modeling, and projection transformations. To integrate haptics with graphics, one more transformation that maps the model to work space coordinate should be added. The following shows an example of how to obtain the workspacemodel transformation from the modelview and projection transformations.

glGetDoublev (GL_MODELVIEW_MATRIX, modelview);

glGetDoublev (GL_PROJECTION_MATRIX, projection);

hduMapWorkspaceModel (modelview, projection, workspacemodel);

After applying the workspacemodel in an OpenGL matrix stack, objects in the work space may be displayed properly on the screen without complicated transformation calculation.

Using the workspacemodel obtained from the hduMapWorkspaceModel function call, the end-effecter (e.g., 15 cm-long) and its movement in the work space can be visualized on the screen. Implementation of the visualization may be expressed as exemplified codes below:

hdGetDoublev(HD_CURRENT_POSITION, position);
hdGetDoublev(HD_CURRENT_TRANSFORM, transform);
glPushMatrix( );
glMultMatrixd(workspacemodel);
glPushMatrix( );
glTranslatef(position[0], position[1], position[2]);
drawCoordination( );
glPopMatrix( );
glMultMatrixd(pState->transform);
glBegin(GL_LINES);
glVertex3d(0,0,0);
glVertex3d(0,0,150);
glEnd( );
glTranslatef(0,0,150);
drawCoordination( );
glPopMatrix( );

The tip position may be obtained by using the exemplified calculation below:

tipPosition[0]=position[0]+(transform[8]*150);

tipPosition[1]=position[1]+(transform[9]*150);

tipPosition[2]=position[2]+(transform[10]*150);

### V. REFERENCES

The following references are referred to as an aid to explain and enable the present embodiments. In several instances, the references have been referenced by their preceding number references.

[2] K. McHale and S. Cermak, Fine Motor Activities in Elementary School: Preliminary Findings and Provisional Implications for Children with Fine Motor Problems, 46 Am. J. Occupational Therapy 898-903 (1992).

[3] M. H. Tseng and S. M. Chow, Perceptual-Motor Function of School-Age Children with Slow Handwriting Speed, 54 Am. J. Occupational Therapy 83-88 (2000).

[4] M. J. Volman et al., Handwriting Difficulties in Primary School Children, 60 Am. J. Occupational Therapy 451-60 (2006).

[5] L. L. Lamme, Handwriting in an Early Childhood Curriculum, 35 Young Children 20-27 (1979).

[6] M. Benbow, Principles and Practices of Teaching Handwriting, in Hand Function in the Child: Foundations for Remediation 255-281 (A. P. Henderson ed. 1995).

[7] K. E. Beery, The Beery-Buktenica Developmental Test of Visual-Motor Integration (Modem Curriculum Press, Pearson Learning Grp. 1989).

[8] P. Denton et al., The Effects of Sensormotor-based Intervention Versus Therapeutic Practice on Improving handwriting Performance of 6- to 11-Year Old Children, 60 Am. J. Occupational Therapy 16-27 (2006).

[9] K. L. Laszlo and P. J. Bairstow, The Kinesthetic Sensitivity Test (Senkit 1985).

[10] M. D. Levine, Developmental Variation and Learning Disorders (Educators Publ'g Serv. 1987).

[11] J. Case-Smith, Effectiveness of School-Based Occupational Therapy Intervention on Handwriting, 56 Am. J. Occupational Therapy 17-25 (2002).

[12] C. Oliver, A Sensorimotor Program for Improving Writing Readiness Skills in Elementary-Age Children, 44 Am. J. Occupational Therapy 111-16 (1990).

[13] J. Lockhart and M. Law, The Effectiveness of a Multisensory Writing Programme for Improving Cursive Writing Ability in Children with Sensorimotor Difficulties, 61 Can. J. Occupational Therapy 206-14 (1994).

[14] J. Z. Olsen, Handwriting Without Tears (5^{th} ed. 1999).

[15] D. Marr and S. B. Dimeo, Outcomes Associated with a Summer Handwriting Course for Elementary Students, 60 Am. J. Occupational Therapy 10-15 (2006).

[23] P. Bonifacci, Children with Low Motor Ability Have Lower Visual-Motor Integration Ability But Unaffected Perceptual Skills, 23 Human Movement Sci. 157-68 (2004).

[24] P. H. Wilson and B. E. McKenzie, Information Processing Deficits Associated with Developmental Coordination Disorder: A Meta-analysis of Research Findings, 36 J. Child Psychol. & Psychiatry & Allied Disciplines 829-40 (1998).

[27] M. S. Graziano and C. G. Gross, Spatial Maps for the Control of Movement, 8 Current Op. Neurobio. 195-201 (1998).

[28] M. Jeannerod et al., Grasping Objects: The Cortical Mechanisms of Visuomotor Transformation, 18 Trends in Neuroscis. 314-20 (1995).

[29] S. Obayashi et al., Macaque Prefrontal Activity Associated with Extensive Tool Use, 13 Neuroport 2349-54 (2002).

[30] A. Maravita and A. Iriki, Tools for the Body (Schema), 8 Trends in Cognitive Scis. 79-86 (2004).

[31] Letter from A. Karni et al., Functional MRI Evidence for Adult Motor Cortex Plasticity During Motor Skill Learning, 377 Nature 155-58 (1995).

[32] J. Classen et al., Rapid Plasticity of Human Cortical Movement Representation Induced by Practice, 79 J. Neurophysiol. 1117-23 (1998).

[33] C. Braun et al., Dynamic Organization of the Somatosensory Cortex Induced by Motor Activity, 124 Brain 2259-67 (2001).

[34] A. D. Wuhle et al., Effects of Motor Activity on the Organization of Primary Somatosensory Cortex, 17 Neurorep. 39-43 (2006).

[35] C. Butefisch et al., Repetitive Training of Isolated Movements Improves the Outcome of Motor Rehabilitation of the Centrally Paretic Hand, 130 J. Neurological Scis. 59-68 (1995).

[36] E. Taub et al., Constraint-Induced Movement Therapy: A New Approach to Treatment in Physical Rehabilitation, 43 Rehab. Psychol. 152-70 (1998).

[37] A. Kunkel et al., Constraint-Induced Movement Therapy for Motor Recovery in Chronic Stroke Patients, 80 Archives Physical Med. & Rehab. 624-28 (1999).

[38] S. Hakkennes and J. L. Keating, Constraint-Induced Movement Therapy Following Stroke: A Systematic Review of Randomised Controlled Trials, 51 Austl. J. Physiotherapy 221-31 (2005).

[39] J. H. van der Lee, Constraint-Induced Movement Therapy: Some Thoughts about Theories and Evidence, 41 J. Rehab. Med. 41-45 (Supp. 2003).

[40] J. Liepert et al., Motor Cortex Plasticity During Constraint-Induced Movement Therapy in Stroke Patients, 250 Neurosci. Letters 5-8 (1998).

[41] F. Hamzei et al., Two Different Reorganization Patterns After Rehabilitative Therapy: An Exploratory Study With fMRI and TMS, 31 Neuroimage 710-20 (2006).

[42] E. P. Taub et al., A Placebo-Controlled Trial of Constraint-Induced Movement Therapy for Upper Extremity After Stroke, 37 Stroke 1045-49 (2006).

[43] E. Taub, Movement in Nonhuman Primates Deprived of Somatosensory Feedback, 4 Exercise & Sport Sci. Rev. 335-74 (1977).

[44] B. T. Volpe et al., Robot Training Enhanced Motor Outcome in Patients with Stroke Maintained in Three Year Follow-Up, 52 Neurology A16 (6 Suppl 2 1999).

[45] B. T. Volpe et al., Is Robot-Aided Sensorimotor Training in Stroke Rehabilitation a Realistic Option?, 14 Current Op. Neurology 745-52 (2001).

[46] S. Jezernik et al., Robotic Orthosis Lokomat: A Rehabilitation and Research Tool, 6 Neuromodulation 108-15 (2003).

[47] M. L. Aisen, M. D. et al., The Effect of Robot-Assisted Therapy and Rehabilitative Training on Motor Recovery Following Stroke, 54 Archives Neurology 443-46 (1997).

[48] P. S. Lum et al., Robot-assisted Movement Training Compared with Conventional Therapy Techniques for the Rehabilitation of Upper-Limb Motor Function After Stroke, 83 Archives Physical Med. & Rehab. 952-59 (2002).

[49] L. E. Kahn et al., Robot-assisted Reaching Exercise Promotes Arm Movement Recovery in Chronic Hemiparetic Stroke: A Randomized Controlled Pilot Study, 3 J. Neuroeng'g & Rehab. 12-24 (2006).

[50] L. Piron et al., Virtual Environment System for Motor Tele-Rehabilitation 85 Stud. Health Tech. Info. 355-61 (2002).

[51] V. Hayward et al., Haptic Interfaces and Devices, 24 Sensor Rev. 16-29 (2004).

[52] J. Deutsch et al., Haptics and Virtual Reality Used to Increase Strength and Improve Function in Chronic Individuals Post-Stroke: Two Case Reports, 26 Neurology Rep. 79-86 (2002).

[53] G. V. Popescu et al., Shared Virtual Environments for Telerehabilitation, 85 Stud. Health Tech. Info. 362-68 (2002).

[54] G. V. Popescu et al., A Virtual-Reality-Based Telerehabilitation System with Force Feedback, 4 IEEE: Transactions Info. Tech. Biomed. 45-51 (2000).

[57] M. E. Neistadt, The Effects of Different Treatment Activities on Functional Fine Motor Coordination in Adults with Brain Injury, 48 Am. J. Occupational Therapy 877-82 (1994).

[58] H. I. Ma, et al., The Effect of Context on Skill Acquisition and Transfer, 53 A. J. Occupational Therapy 138-44 (1999).

[59] D. L. Nelson, et al., The Effects of an Occupationally Embedded Exercise on Bilaterally Assisted Supination in Persons with Hemiplegia, 50 Am. J. Occupational Therapy 639-46 (1996).

[60] E. Bower et al., A Randomised Controlled Trial of Different Intensities of Physiotherapy and Different Goal-Setting Procedures in 44 Children with Cerebral Palsy, 38 Dev. Med. & Child Neurology 226-37 (1996).

[61] G. King et al., The Evaluation of Functional, School-Based Therapy Services for Children with Special Needs: A Feasibility Study, 18 Physical & Occupational Therapy Pediatrics 1-27 (1998).

[62] J. Valvano, Activity-focused Motor Interventions for Children with Neurological Conditions, 24 Physical & Occupational Therapy Pediatrics 79-107 (2004).

[63] C. McLaren, Goal Attainment Scaling: Clinical Implications for Pediatric Occupational Therapy Practice, 50 Austl. J. Occupational Therapy 216-24 (2003).

[64] A. Young and R. Chesson, Goal Attainment Scaling as a Method of Measuring Clinical Outcome for Children with Learning Disabilities, 60 Brit. J. Occupational Therapy 111 -14 (1997).

[65] C. Missiuna et al., Perceived Efficacy and Goal Setting in Young Children, 67 Can. J. Occupational Therapy 101-09 (2000).

[66] J. Alston, A Legibility Index: Can Handwriting be Measured?, 35 Educ. Rev. 237-42 (1983).

[67] M. Tseng and S. Cermak, The Influence of Ergonomic Factors and Perceptual-Motor Abilities on Handwriting Performance, 47 Am. J. Occupational Therapy 919-26 (1993).

[68] J. Ziviani and J. Elkins, An Evaluation of Handwriting Performance, 36 Educ. Rev. 249-61 (1984).

[69] S. Amundson, Evaluation Tool of Children's Handwriting (OT KIDS 1995).

[70] P. Sudsawad, The Effect of Kinesthetic Training on Handwriting Performance in Grade One Children with Handwriting Difficulties (B.U. 2000).

In this specification, “a” and “an” and similar phrases are to be interpreted as “at least one” and “one or more.”

Many of the elements described in the disclosed embodiments may be implemented as modules. A module is defined here as an isolatable element that performs a defined function and has a defined interface to other elements. The modules described in this disclosure may be implemented in hardware, software, firmware, wetware (i.e., hardware with a biological element) or a combination thereof, all of which are behaviorally equivalent. For example, modules may be implemented as a software routine written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++or the like. FPGAs, ASICs and CPLDs are often programmed using hardware description languages (HDL), such as VHSIC hardware description language (VHDL) or Verilog, that configure connections between internal hardware modules with lesser functionality on a programmable device. Finally, it needs to be emphasized that the above mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) of embedding a block authentication code in a data stream for authentication purposes. However, one skilled in the art will recognize that embodiments of the invention could be used to embed other types of information in the data blocks such as hidden keys or messages. One of many ways that this could be accomplished is by using a specific hash function that results in a value that either directly or in combination with other data can result in one learning this other type of information.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A tangible computer readable medium encoded with computer readable instructions that when executed by one or more processors executes a method for assessing an individual's fine-motor skills using a force-feedback haptic unit having an end-effecter and programmable settings comprising:
a. initializing the programmable settings with a set of initial settings;
b. presenting a 3-D representation of at least one character to a user;
c. prompting the user to mimic the character on a work space;
d. collecting timed stroke data from the force-feedback haptic unit while the user is attempting to mimic the character using the end-effecter on the work space; and
e. generating an analysis to determine the user's precision and accuracy using the timed stroke data.

2. The medium according to claim 1, further including controlling the force-feedback haptic unit while the user is attempting to mimic the character using the end-effecter on the work space.

3. The medium according to claim 1, further including using the analysis to present real-time visual feedback.

4. The medium according to claim 3, wherein the real-time visual feedback includes at least one of the following:
a. an image of at least one stroke;
b. an image of at least one stroke overlaid on an image of the character;
c. statistical data comprising:
i. hit rate data;
ii. error rate data;
iii. accuracy data;
iv. directional accuracy data;
v. summary data; and
vi. any combination of the above; and
d. any combination of the above.

5. The medium according to claim 1, wherein both the collecting timed stroke data and the generating an analysis are repeated multiple times.

6. The medium according to claim 5, wherein the analysis includes summary data for the timed stroke data that are collected through the multiple times.

7. The medium according to claim 6, wherein the summary data includes at least one of the following:
a. statistics;
b. time-series analysis; and
c. user-defined settings for the force-feedback haptic unit.

8. The medium according to claim 1, wherein the character is described by at least one of the following:
a. a quadratic curve;
b. a cubic curve;
c. a Bezier curve;
d. a polynomial equation; and
e. any combination of the above.

9. The medium according to claim 1, wherein the timed stroke data includes a timed sequence of x, y, and z coordinate data.

10. The medium according to claim 1, wherein the timed stroke data includes lift data, the lift data including a curve in a plane substantially perpendicular to the work space.

11. The medium according to claim 1, further including adjusting the programmable settings using updated settings received from a trainer in response to the analysis.

12. The medium according to claim 11, wherein a plan is considered when setting the updated settings, the plan being one of the following:
a. a therapeutic intervention plan;
b. a treatment plan;
c. a guided plan; or
d. any combination of the above.

13. The medium according to claim 1, wherein the force-feedback haptic unit is configured to communicate with a remote force-feedback haptic unit.

14. The medium according to claim 1, wherein a trainer operates the force-feedback haptic unit.

15. The medium according to claim 14, wherein the trainer operates the force-feedback haptic unit using an asynchronous “store and forward” operation.

16. The medium according to claim 14, wherein the trainer operates the force-feedback haptic unit using an interactive synchronous operation.

17. The medium according to claim 1, further including moving the end-effecter to a starting point.

18. The medium according to claim 1, wherein the force-feedback haptic unit is adjustable to accommodate different types of end-effecters.
